(19) United States
(12) Patent Application Publication
(10) Pub. No.: US 2015/0224526 A1
(43) Pub. Date: Aug. 13, 2015

(54) Sprayrite wheel cover

(71) Applicant: Randy Jack Devine, Riverdale, GA (US)

(72) Inventor: Randy Jack Devine, Riverdale, GA (US)

(21) Appl. No.: 14/120,321

(22) Filed: Feb. 7, 2014

(51) Int. Cl. B05B 15/04

(52) U.S. Cl. CPC B05B 15/0487

(57) ABSTRACT

The Sprayrite Wheelcover is a device that can be used to detail your favorite vehicle and decrease time and energy necessary to remove greasy overspray. Place the wheel cover over the vehicle rim, then apply your favorite tire dressings. When the cover is removed there will be no messy, greasy overspray to be removed from the rim.

The Sprayrite Wheel Cover will vary in diameter ranging from 14 inches to 28 inches according to the user's wheel size.

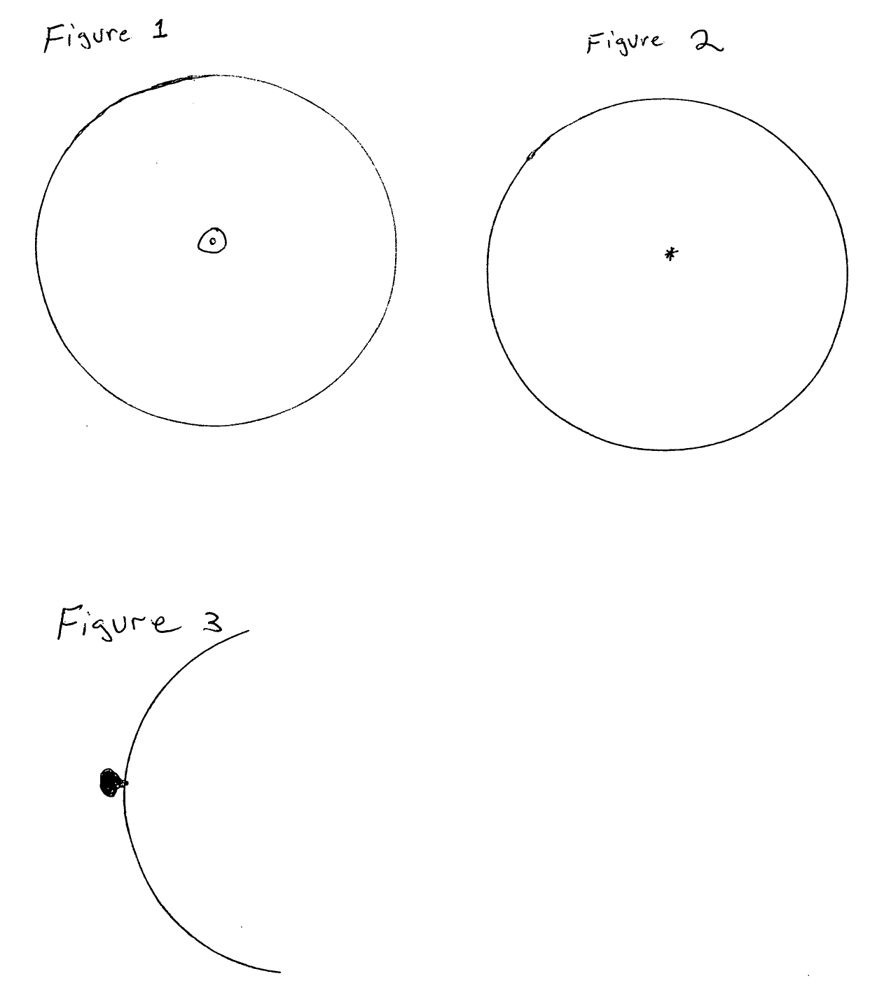

(FIG. 1-front view and FIG. 2-back view). The Sprayrite Wheel Cover is ⅛ inch thick. The cover has a handle 2 inches in diameterfor easy handling. (FIG. 3-side view). The wheel cover has a 3 inch indention to compensate for any wheel bulging. (FIG. 3-side view)

1. The Sprayrite Wheelcover is a circular device that may be used to protect vehicle rims from messy spray-on or wipe-on tire dressing. Sprayrite Wheelcover will shorten the detailing time of your favorite ride.
